(19) United States
(12) Patent Application Publication
(10) Pub. No.: US 2008/0118357 A1
(43) Pub. Date: May 22, 2008

(54) TURBOFAN AND MANUFACTURING METHOD THEREOF

(75) Inventors: Jong Ki JEON, Suwon-si (KR); Sung Kwan Park, Suwon-si (KR); Yong Ho Lee, Yongin-si (KR); Dae Sung Lee, Suwon-si (KR); Jei Min Choi, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/782,807

(22) Filed: Jul. 25, 2007

(30) Foreign Application Priority Data
Nov. 20, 2006 (KR) 2006-114799

(51) Int. Cl. F04D 29/28; B23P 15/02

(52) U.S. Cl. 416/185; 249/187.1; 29/888.025; 29/889.2; 416/189

(57) ABSTRACT

A turbofan integrally formed with a shroud and a method of manufacturing the same. The turbofan includes a rotating plate rotated by a driving motor, a plurality of blades having first ends connected to an outer peripheral portion of a front surface of the rotating plate while being arranged in a radial pattern, a shroud having an annular shape and being integrally formed with second ends of the blades, in which the shroud has an inner diameter equal to or larger than a diameter of the rotating plate, and an auxiliary rotating plate having a diameter larger than the diameter of the rotating plate and being fixed to the rotating plate. Since the inner diameter of the shroud is equal to or larger than the rotating plate, the turbofan is integrally formed with the shroud by a mold.

### CROSS-REFERENCE TO RELATED APPLICATIONS

This application claims the benefit of Korean Patent Application No. 2006-114799, filed on Nov. 20, 2006, in the Korean Intellectual Property Office, the disclosure of which is incorporated herein by reference in its entirety.

### BACKGROUND OF THE INVENTION

1. Field of the Invention

The present general inventive concept relates generally to a turbofan, and more particularly to a turbofan integrally formed with a shroud, and a manufacturing method thereof.

2. Description of the Related Art

In general, a turbofan is a type of centrifugal fan that blows air in a radially outward direction by receiving the air in an axial direction. Such a turbofan, as disclosed in Japanese Unexamined Patent Publication No. 2002-188594, includes a rotating plate provided in the center of the turbofan and coupled to a rotating shaft of a driving motor so as to be rotated by means of the driving motor, a plurality of blades coupled an outer circumferential surface of the rotating plate and aligned in a radial pattern along the outer circumferential surface of the rotating plate, and a shroud having a ring shape and being coupled to a front end of each blade.

Typically, the turbofan is fabricated through a plastic injection molding process. However, the turbofan causes many undercuts that make it difficult to separate a product from a mold, so the turbofan cannot be integrally formed through a one-step molding process. For this reason, in general, the shroud is fabricated separately from the turbofan, and then after the shroud is fabricated, the shroud is fixed to the blade through ultrasonic welding or thermal bonding.

However, if the shroud is separately fabricated and then is coupled to the turbofan, strength of a connection part between the blade and the shroud becomes weaker than that of other parts. In addition, since the connection part between the shroud and the blade has a narrow area, the connection part may be damaged if vibration that occurs during the rotation of the turbofan exerts influence upon the connection part for a long period of time.

### SUMMARY OF THE INVENTION

The present general inventive concept provides a turbofan integrally formed with a shroud.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a turbofan including a rotating plate rotated by means of a driving motor, a plurality of blades having first ends connected to an outer peripheral portion of a front surface of the rotating plate while being arranged in a radial pattern, a shroud having an annular shape and being integrally formed with second ends of the blades, in which the shroud has an inner diameter equal to or larger than a diameter of the rotating plate, and an auxiliary rotating plate having a diameter larger than the diameter of the rotating plate and being fixed to the rotating plate.

The diameter of the auxiliary rotating plate is equal to or larger than an outer diameter of the shroud.

A hub protrudes forward from a center of the rotating plate where the driving motor is installed, and the auxiliary rotating plate has an annular shape corresponding to a shape of the rotating plate so that the auxiliary rotating plate is attachable to an outer circumferential portion of the rotating plate.

An outer diameter of the auxiliary rotating plate is equal to or larger than an outer diameter of the shroud.

A front surface of the auxiliary rotating plate is fixed to a rear surface of the rotating plate through fusion welding.

The foregoing and/or other aspects and utilities of the present general inventive concept may be achieved by providing a method of manufacturing a turbofan including a rotating plate rotated by a driving motor, a plurality of blades having first ends connected to an outer peripheral portion of a front surface of the rotating plate while being arranged in a radial pattern, and a shroud having an annular shape and being integrally formed with second ends of the blades, in which the shroud has an inner diameter equal to or larger than a diameter of the rotating plate, the method including fabricating the turbofan using a mold such that the rotating plate, the blades, and the shroud are integrally formed with each other, and fixing an auxiliary rotating plate having a diameter larger than a diameter of the rotating plate to the turbofan fabricated by using the mold.

The foregoing and/or other aspects and utilities of the present general inventive concept may also be achieved by providing a turbofan including a rotating plate having a cone-shaped hub at a center portion thereof, plurality of blades having first ends connected to an outer peripheral portion of a front surface of the rotating plate while extending radially with respect to a rotation axis of the rotating plate, a shroud sharing a common rotation axis with the rotating plate and being integrally formed with an outer portion of the second ends of the blades, and an auxiliary rotating plate being fixed to the outer peripheral portion of a rear surface of the rotating plate and extending past an edge of the rotating plate in the radial direction.

The auxiliary rotating plate, the rotating plate and the shroud may share a common rotation axis.

The foregoing and/or other aspects and utilities of the present general inventive concept may also be achieved by providing a mold to form a turbofan integrally formed with a shroud, the mold including a first mold portion formed with a first front surface molding section, which is formed at a center of the first mold portion to form a front surface of a rotating plate and inner portions of blades, and a second front surface molding section which is recessed at an outer portion of the first front surface molding section with a predetermined curvature corresponding to a front surface of the shroud to form the front surface of the shroud, and a second mold portion formed with a first rear surface molding section, which is formed at a center of the second mold portion to form a rear surface of the rotating plate, and a plurality of second rear surface molding sections, which are formed at an outer portion of the first rear molding section while protruding toward the first mold portion to form a rear surface of the shroud and the blades.

The second rear surface molding section is formed with a plurality of second blade molding grooves, which are aligned in the circumferential direction of the second rear surface molding section while being spaced apart from each other by a predetermined distance to form inner end portions of the blades.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating a turbofan according to an embodiment of the present general inventive concept;

FIG. 2 is an exploded sectional view illustrating a mold used to manufacture a turbofan according to an embodiment of the present general inventive concept; and

FIG. 3 is a sectional view illustrating a turbofan according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

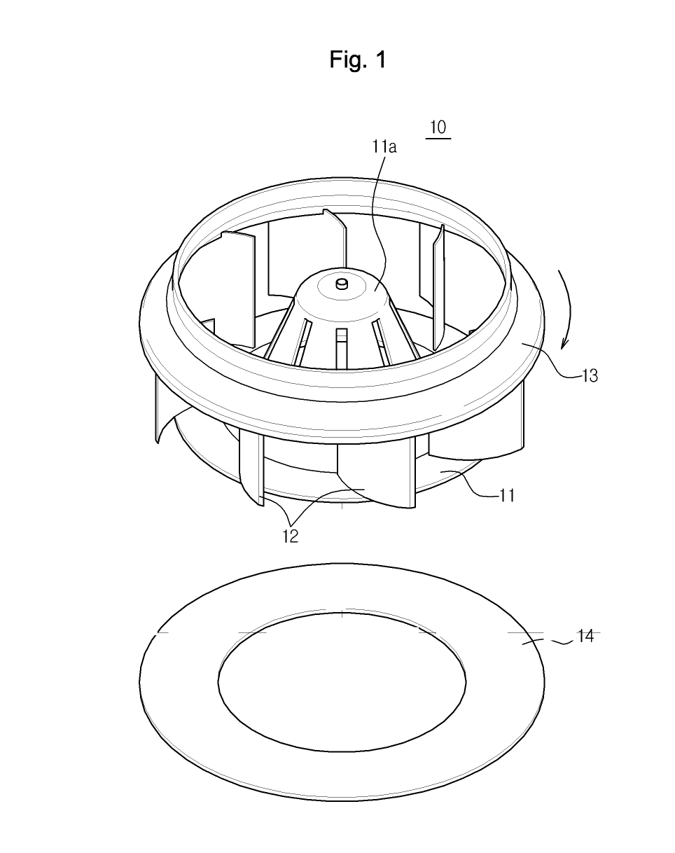

As illustrated in FIG. 1, a turbofan 10 according to an embodiment of the present general inventive concept includes a rotating plate 11 having a circular shape and be coupled to a rotating shaft (not illustrated) of a driving motor (not illustrated) so as to be rotated by the driving motor, a plurality of blades integrally coupled to an outer circumferential surface of the rotating plate 11 and aligned in a radial pattern along the outer circumferential surface of the rotating plate 11, and a shroud 13 having an annular shape and being integrally formed with the other end of the blade 12. In the following description, for the purpose of explanation, the term “front side of the turbofan” refers to a side where the shroud 13 is positioned and the term “rear side of the turbofan” refers to a side where the rotating plate 11 is positioned.

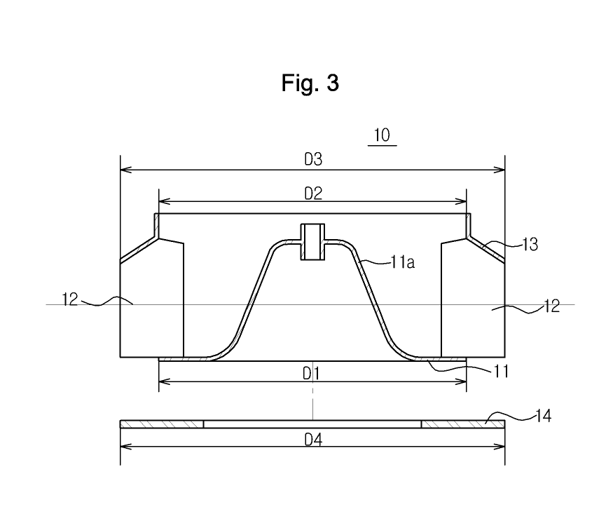

In addition, a hub 11a is provided at the center of the rotating plate 11 so as to mount the rotating shaft of the driving motor thereon. The hub 11a protrudes forward in a frusto-conical shape in such a manner that the turbofan 10 can be stably rotated. As illustrated in FIG. 3, the blades 12 are inclined relative to the radial direction of the rotating plate 11 by a predetermined angle. In addition, the annular-shaped shroud 13 has a predetermined curvature section so as to guide air when the air is introduced along an inner surface thereof or exhausted therefrom in a radial direction.

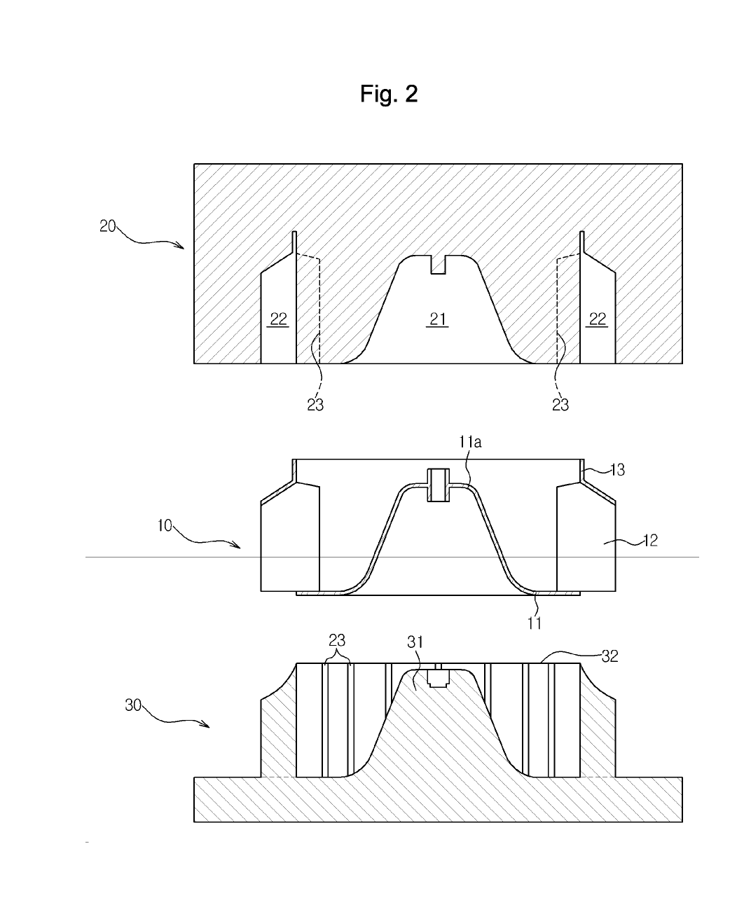

As illustrated in FIG. 2, a mold used to manufacture the turbofan 10 integrally formed with the shroud 13 includes first and second molds 20 and 30, which are detachably coupled with each other.

The first mold 20 is formed with a first front surface molding section 21, which is formed at the center of the first mold 20 so as to form a front surface of the rotating plate 11 and inner end portions of the blades 12, and a second front surface molding section 22, which is recessed at an outer portion of the first front surface molding section 21 with a predetermined curvature corresponding to a front surface of the shroud 13 so as to form the front surface of the shroud 13. In addition, the first front surface molding section 21 is formed with a plurality of first blade molding grooves 23, which are aligned in the circumferential direction of the first front surface molding section 21 while being spaced apart from each other by a predetermined distance so as to form inner end portions of the blades 12.

The second mold 30 is formed with a first rear surface molding section 31, which is formed at the center of the second mold 30 so as to form a rear surface of the rotating plate 11, and a plurality of second rear surface molding sections 32, which are formed at an outer portion of the first rear surface molding section 21 while protruding toward the first mold 20 so as to form the rear surface of the shroud 13 and the blades 12. In addition, the second rear surface molding section 32 is formed with a plurality of second blade molding grooves 33, which are aligned in the circumferential direction of the second rear surface molding section 32 while being spaced apart from each other by a predetermined distance so as to form inner end portions of the blades 12.

When the first mold 20 is coupled with the second mold 30, the second rear surface molding section 32 of the second mold 30 is introduced into the second front surface molding section 22 of the first mold while occupying a region where outer end portions of the blades are to be formed. In order to facilitate the coupling/decoupling between the first and second molds 20 and 30, inner and outer diameters of the second rear surface molding section 32 correspond to inner and outer diameters of the second front surface molding section 22.

Accordingly, after coupling the first mold 20 with the second mold 30 such that a molding cavity can be formed therebetween, molten resin is poured into the molding cavity and then is cured. As a result, the turbofan 10 can be integrally formed with the shroud 13.

In the turbofan 10 integrally fabricated with the shroud 13 through the molding process, the shroud 13 is formed by the first front surface molding section 21, the second front surface molding section 22 formed at the outer portion of the first rear surface molding section 31, and the second rear surface molding sections 32, so an inner diameter D2 of the shroud 13 formed by the second front surface molding section 22 and the second rear surface molding section 32 is equal to or larger than a diameter D1 of the rotating plate 11 formed by the first front surface molding section 21 and the first rear surface molding section 31, as illustrated in FIG. 3. Therefore, the turbofan 10 integrally formed with the shroud 13 can be fabricated by allowing the inner diameter D2 of the shroud 13 to have a size equal to or larger than the size of the diameter D1 of the rotating plate 11.

In addition, if the second diameter D2 of the shroud 13 is designed larger than the diameter D1 of the rotating plate 11, a part of air introduced into the shroud 13 may interfere with the rotating plate 11, so that the air is partially introduced into the rear side of the turbofan 10, causing vibration and noise of the turbofan 10.

For this reason, the turbofan 10 being integrally formed with the shroud 13 according to the present general inventive concept also includes an auxiliary rotating plate 14 having a diameter D4 larger than the diameter D1 of the rotating plate 11 and being fixed to the rotating plate 11 so as to reduce an amount of air flowing toward the rear side of the turbofan 10.

The present general inventive concept also provides a method of manufacturing the turbofan 10, in which the method includes fabricating the turbofan 10 using the mold such that the rotating plate 11, the blades 12, and the shroud 13 can be integrally formed with each other, and fixing the auxiliary rotating plate 14 having the diameter larger than that of the rotating plate 11 to the turbofan 10 fabricated by using the mold.

The auxiliary rotating plate 14 assists the rotating plate 11 so as to guide air, which is introduced into the turbofan 10 through the shroud 13, in a radially outward direction. That is, since the rotating plate 11 inevitably has the diameter D1 equal to or smaller than the inner diameter D2 of the shroud 13 such that the rotating plate 11 can be integrally formed with the shroud 13, the auxiliary rotating plate 14 is provided to assist the function of the rotating plate 11. At this time, the auxiliary rotating plate 14 preferably has a diameter D4 equal to or larger than the outer diameter D3 of the shroud 13 in order to reduce the amount of air introduced into the rear side of the turbofan 10. Therefore, the air introduced into the turbofan 10 through the shroud 13 is guided by the auxiliary rotating plate 13 as well as the rotating plate 11, so most air is exhausted radially outward of the turbofan 10. Thus, the amount of air introduced into the rear side of the turbofan 10 can be significantly reduced due to the auxiliary rotating plate 14, so that noise generated from the turbofan 10 can be reduced.

According to the present embodiment, the hub 11a is provided at the center of the rotating plate 11. Thus, the auxiliary rotating plate 14 has an annular shape corresponding to the shape of the rotating plate 11 such that the auxiliary rotating plate 14 can be attached to an outer circumferential portion of the rotating plate 11, and the outer diameter D4 of the auxiliary rotating plate 14 is equal to or larger than the outer diameter D3 of the shroud 13.

The front surface of the auxiliary rotating plate 14 can be fixed to the rear surface of the rotating plate 11 through ultrasonic welding or thermal bonding, so the auxiliary rotating plate 14 fixedly makes surface-contact with the rotating plate 11. Therefore, although vibration which is inevitably generated when the turbofan 10 is rotated is applied to a coupling section between the rotating plate 11 and the auxiliary rotating plate 14, this vibration is evenly distributed through the rear surface of the rotating plate 11 and the front surface of the auxiliary rotating plate 14, so the auxiliary rotating plate 14 can be stably fixed to the rotating plate 11.

As described above, according to the turbofan of the present general inventive concept, the inner diameter of the shroud 13 is equal to or larger than the outer diameter of the rotating plate 11, so the turbofan can be integrally formed with the shroud 13 by using the mold.

In addition, according to the turbofan of the present general inventive concept, the auxiliary rotating plate 14 having the diameter larger than the rotating plate 11 is fixed to the rotating plate, so the amount of air introduced into the rear side of the turbofan can be significantly reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A turbofan comprising:
a rotating plate rotated by a driving motor;
a plurality of blades having first ends connected to an outer peripheral portion of a front surface of the rotating plate while being arranged in a radial pattern;
a shroud having an annular shape and being integrally formed with second ends of the blades, in which the shroud has an inner diameter equal to or larger than a diameter of the rotating plate; and
an auxiliary rotating plate having a diameter larger than the diameter of the rotating plate and being fixed to the rotating plate.

2. The turbofan as claimed in claim 1, wherein the diameter of the auxiliary rotating plate is equal to or larger than an outer diameter of the shroud.

3. The turbofan as claimed in claim 1, wherein a hub protrudes forward from a center of the rotating plate where the driving motor is installed, and the auxiliary rotating plate has an annular shape corresponding to a shape of the rotating plate so that the auxiliary rotating plate is attachable to an outer circumferential portion of the rotating plate.

4. The turbofan as claimed in claim 3, wherein an outer diameter of the auxiliary rotating plate is equal to or larger than an outer diameter of the shroud.

5. The turbofan as claimed in claim 1, wherein a front surface of the auxiliary rotating plate is fixed to a rear surface of the rotating plate through fusion welding.

6. A method of manufacturing a turbofan including a rotating plate rotated by a driving motor, a plurality of blades having first ends connected to an outer peripheral portion of a front surface of the rotating plate while being arranged in a radial pattern, and a shroud having an annular shape and being integrally formed with second ends of the blades, in which the shroud has an inner diameter equal to or larger than a diameter of the rotating plate, the method comprising:
fabricating the turbofan using a mold such that the rotating plate, the blades, and the shroud are integrally formed with each other; and
fixing an auxiliary rotating plate having a diameter larger than a diameter of the rotating plate to the turbofan fabricated by using the mold.

7. A turbofan comprising:
a rotating plate having a cone-shaped hub at a center portion thereof;
a plurality of blades having first ends connected to an outer peripheral portion of a front surface of the rotating plate while extending radially with respect to a rotation axis of the rotating plate;
a shroud sharing a common rotation axis with the rotating plate and being integrally formed with an outer portion of the second ends of the blades; and
an auxiliary rotating plate being fixed to the outer peripheral portion of a rear surface of the rotating plate and extending past an edge of the rotating plate in the radial direction.

8. The turbofan of claim 7, wherein the auxiliary rotating plate, the rotating plate and the shroud sharing a common rotation axis.

9. A mold to form a turbofan integrally formed with a shroud, the mold comprising:
a first mold portion formed with a first front surface molding section, which is formed at a center of the first mold portion to form a front surface of a rotating plate and inner portions of blades, and a second front surface molding section which is recessed at an outer portion of the first front surface molding section with a predetermined curvature corresponding to a front surface of the shroud to form the front surface of the shroud; and
a second mold portion formed with a first rear surface molding section, which is formed at a center of the second mold portion to form a rear surface of the rotating plate, and a plurality of second rear surface molding sections, which are formed at an outer portion of the first rear molding section while protruding toward the first mold portion to form a rear surface of the shroud and the blades.

10. The mold as claimed in claim 9, wherein the second rear surface molding section is formed with a plurality of second blade molding grooves, which are aligned in the circumferential direction of the second rear surface molding section while being spaced apart from each other by a predetermined distance to form inner end portions of the blades.
